(19) United States
(12) Patent Application Publication
(10) Pub. No.: US 2010/0227525 A1
(43) Pub. Date: Sep. 9, 2010

(54) Book with removable objects

(76) Inventor: Hejira La Shon Smith, San Diego, CA (US)

Correspondence Address: Hejira Smith, 8430 Capricorn Way #5, San Diego, CA, 92126, US

(21) Appl. No.: 12/398,252

(22) Filed: Mar. 5, 2009

(51) Int. Cl. A63H 33/38; B42D 1/00; B42D 3/00

(52) U.S. Cl. 446/149; 281/21.1; 281/29

(57) ABSTRACT

A book with removable objects comprising a plurality of card board sheets printed on both sides, cut to form removable insert, folded, and bound together as page(s), allowing for printed material to be visible in the insert cavity once the removable insert is extracted.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to the composition of books, specifically to the construction of books with removable objects.

2. Prior Art

Teachers and parents alike read to young children because it gets them thinking creatively, sets reading up as an enjoyable activity, gives children an appreciation and respect for books, and promotes language and vocabulary development.

When an older child, adolescent, or adult reads a traditional paper book, there are few concerns to address because they can (1) read the words found on the pages of the book, (2) cognitively engage themselves in the information presented in the book, and (3) separate and turn the pages of the book without help. However, when a young child picks up a book with paper pages, it is not the same. The words on the page do not yet hold a meaning, there is limited engagement in the content of the book, and the individual sheets are too difficult to manipulate for the developing fine-motor skills of a young child. Books then become too difficult for young children, inevitably leading to the destruction, through tearing of or coloring on the pages, of the book by the bored child.

There have been several attempts to rectify these short-comings, so that books can be enjoyed by and perhaps even challenge, young children. “Board books”, with each page formed by gluing two pieces of “board” together, allows for page manipulation. While the pages are bigger, thus becoming easier to grasp for young children, the simple pictures and phrases do little to keep young children engaged in the book for more than a couple minutes.

“Lift-the-flap”, “lift-a-flap”, or just “flap books”, U.S. Pat. No. 6,951,352, are board books that contain three sided die cuts into one of the two pieces of the board that are glued together; forming a non-removable flap. This allows for a question or riddle to be posed to the child, with the answer revealed once the flap is lifted or moved. While the ability to lift pieces will aid in engaging young children, the format is limited to either question asking or peek-a-boo activities, which may still be too advanced for a child of 18 months to three years old.

Magnetic books, U.S. Pat. Nos. 4,702,700 and 6,217,405, include a magnetized area with corresponding magnetized objects that are provided with the book. The same level of functionality and novelty can be reached without the additional process of magnetizing the book and corresponding objects.

Puzzle books, U.S. Pat. Nos. 5,683,112; 5,213,507; and 3,815,920, have been constructed of various materials and contain a multi-piece puzzle typically found on the back side of the front cover. While this additional puzzle activity adds to the challenge and enjoyment of the book, a puzzle with multiple interlocking pieces is far too advanced for a young child to properly operate.

Books constructed of foam, U.S. Pat. No. 6,189,932, contain pieces that can be removed from the book, and then fitted onto an interlocking flat stand, also contained within the pages of the book. The stand may also interlock with other stands from other pieces or shapes. The main function of this book, and the foam construction, is to provide children with a bath time toy. The characters are attached to stands so they can float on the water. This not only would require caregiver support for young children to properly put pieces together, but, the necessity for a character, such as a dog or cat, that can be removed and floated on water puts a limit on the subject matter for the book.

### SUMMARY

In accordance with an embodiment a book with at least one rigid or not easily bent page, cover, or binding; comprises a front cover, a back cover, and a plurality of pages disposed between the front and back cover. At least one of the front cover, back cover, page, or binding includes a removable insert that can be extracted from a corresponding cavity.

Advantages of the present invention including:
Language/cognitive/fine motor development through identifying and matching activities possible with fully removable objects.
Mentally challenging young children in a way that is age appropriate
Ease in overall manipulation; enhanced by the addition of a removal cavity
Easily adaptable to a wide rage of subject matter
Enhanced socialization opportunities as the book creates an activity that is applicable to a group of young children.

### DRAWINGS—FIGURES

FIG. 1 is a perspective view of an embodiment of the present invention wherein the book is in an open position.

FIG. 2 is a perspective view of an embodiment of the present invention wherein the book is in a closed position.

FIG. 3 depicts a top view of an embodiment of the present invention wherein the cover and one page are open.

FIG. 4 depicts a front view of a page.

### DETAILED DESCRIPTION

The following description of the preferred embodiment is presented to illustrate the present invention and is not to be construed to limit the scope of the appended claims in any matter whatsoever.

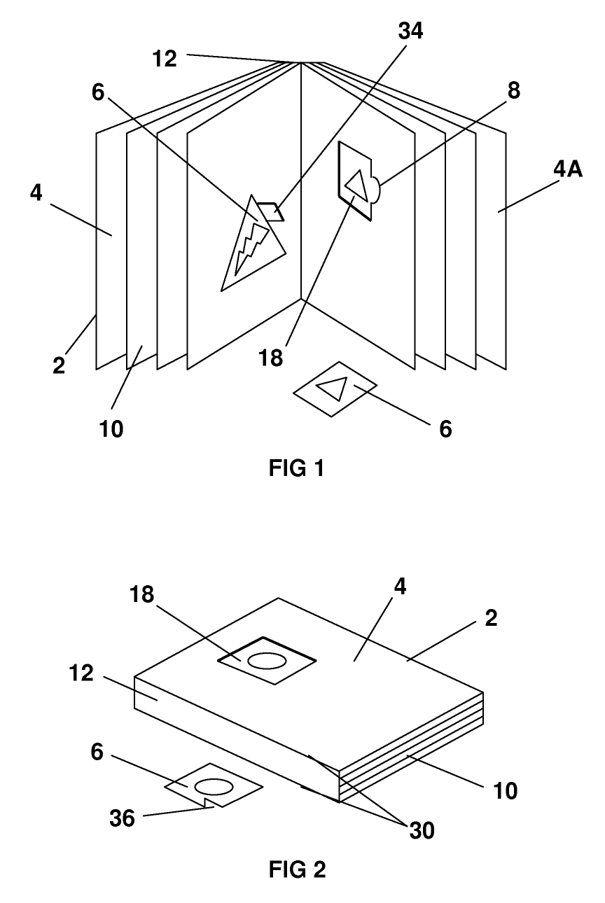

An embodiment of the present invention is illustrated in FIGS. 1 & 2. The book 2 has a front cover 4 with removable insert 6. In the preferred embodiment of the present invention, a side of the removable insert 6 may be provided with one or more semicircular cavities 8 to facilitate extraction of the removable insert 6. However, a side of the removable insert 6 may be provided with any removal facilitator or aid in extraction including, but not limited to, a removal cavity of any shape (32), a tab (34), or a cut out of any shape in the removable insert itself (36), with the purpose of facilitating extraction. The removable insert 6 may optionally be provided on the page(s) 10, cover(s) 4, or even the binding 12 in order maximize space savings as needed to allow for additional artwork or text. When the removable insert 6 is extracted from the cover, page, or binding, the insert cavity 18 underneath is exposed.

The book, 2, comprises a plurality of page(s) 10 that are rigid, or not easily bent, which are bound together via binding 12. The front cover 4 is substantially joined to a back cover 4A via binding 12 which in turn binds the plurality of page(s) 10 to form one substantially unified book piece.

In an embodiment of the present invention, front cover 4, back cover 4A, and binding 12 are formed by adhering two pieces of card or paper board sheets, then making folds 30 in the two sheets to form the front cover 4 which is equal in size to the back cover 4A, and between the front cover 4 and back cover 4A, a binding 12 that is equal in width to the page(s) 10 as they stand when aligned vertically.

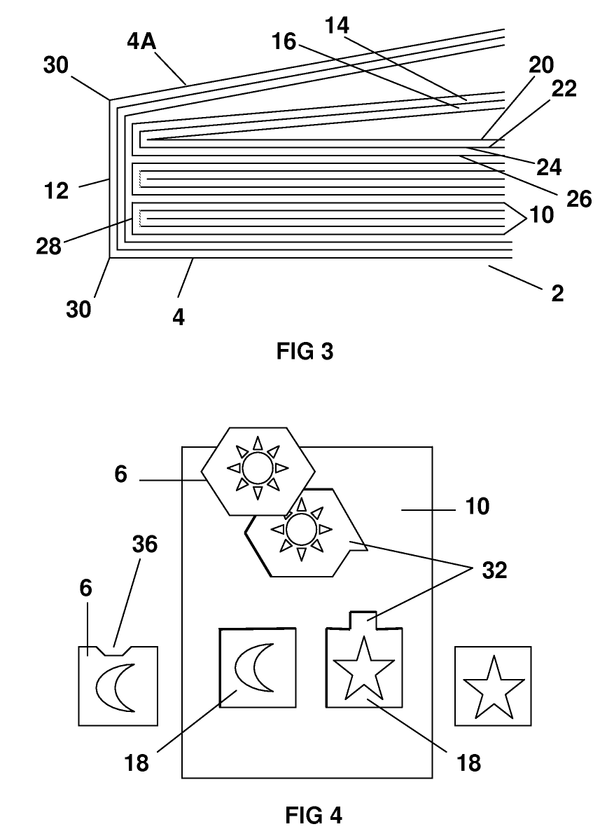

The page(s) 10 are formed by adhering two pieces of card or paper board sheets, then folding to create two separate pages 10, which are then aligned vertically at the hinge 28 and bound to the binding 12 by any book binding method such as gluing or sewing. Each page 10 contains opposing wall layers defined as: wall portion I, 14, and wall portion II, 16, as shown in FIG. 3.

Prior to the creation of wall portion I, 14, and wall portion II, 16, through the adhering and doubling over of two suitable card or paper board sheets, each side of each card or paper board sheet is printed upon. Any printing method may be employed in the practicing of the present invention, including four-color-process printing. The printing occurs so that the inside of wall portion I, 22, as defined by the side of wall portion I, 14, which will be bonded to wall portion II, 16 forming a page 10, will be printed with an image that matches the outside of wall portion II, 24, as defined by the side of wall portion II, 16, which is not bonded to wall portion I, 14. Conversely, the inside of wall portion II, 26, will be printed with an image that matches the outside of wall portion I, 20.

Following printing, the removable insert 6 are cut into the card or paper board sheets. As noted above, the sheets are then bonded together and folded to create two separate pages 10.

The term image refers to anything that might be put on a book page, including: pictures, words or letters, colors, textures, or “scratch and sniff” scents. When stating that the images should match, it is meant that the image in the insert cavity 18 should represent a mental relation or similar theme to the image on the corresponding removable insert 6. Matches could be represented through a picture to picture match on the removable insert 6 and in the insert cavity 18, a picture to word match, a picture to texture match, a picture to scent match, a picture to color match, a word to word match, a word to texture match, a word to scent match, a word to color match, a texture to texture match, a texture to scent match, a texture to color match, a scent to scent match, a scent to color match, a color to color match, the image on the removable insert 6 could complete a bigger picture on the page once embedded into the insert cavity 18, or the actual shape of the removable insert 6 could serve to match the shape of the insert cavity 18.

### Operation—FIG. 4—Frontal Page View

In an embodiment of the present invention, the removable insert 6 is removably disposed in the cavity 18, or fits in the cavity 18 but can be extracted from a page(s) 10, cover(s) 4, or binding 12, through inserting a finger or like object into the removal cavity (8, 32, 34, 36), and applying a slight pressure to the side of the removable insert 6 while pulling said removable insert 6 upward and out of the cavity 18. The opposite procedure is used to embed the removable insert 6 into the cavity 18. The removable insert 6 is placed in the cavity 18 and pressed down upon to securely friction fit the removable insert 6 into the insert cavity 18.

### CONCLUSION, RAMIFICATIONS, AND SCOPE

Accordingly, the reader will see that the book with removable objects is simple enough to be operated by a young child while challenging enough to keep that child engaged in the activity. The book will help young children think creatively while promoting language and vocabulary development; making reading more enjoyable. The production of this book will be less expensive than some of the prior art on the market, such as magnetic books, and can be applied to not only a wide variety of subjects for books, but can be applied to picture books already published on paper. Furthermore, the book with removable objects has the additional advantages in that:
A book constructed of board material allows for use by young children while promoting development of fine-motor skills.
The addition of a removal cavity to one side of the removable object allows for easier removal; adding to the accessibility for young children.
Fully removable objects allow for additional matching activities to be incorporated into the reading of the book; further enhancing the learning opportunities found in reading with young children.
The option to create multiple removable objects throughout the book creates an activity that is applicable to a group of young children; further enhancing socialization opportunities

Although the description above contains much specificity, many variations of the current invention will suggest themselves to those skilled in the art. For example, the removable insert proposed in the present invention can have many shapes, such as circular, oval, trapezoidal, triangular, etc.; may be fitted with various removal facilitators including: a semicircular cavity or cavity of any shape, a tab, or cut out in the removable insert itself; and may be fitted with a variety of materials including pictures, words or letters, textures, colors, or scents. The book itself does not need to be composed entirely of a card or paper board material; just the covers, a single page, or various pages throughout the book can be composed of a card or paper board material. In addition, there is no limit to the number of removable inserts that can be cut into each book.

The match between the removable insert and corresponding insert cavity could be made through matching the same picture on the insert to the same picture in the cavity, making a different picture to picture match, a picture to word match, a picture to texture match, a picture to scent match, a picture to color match, a word to word match, a word to texture match, a word to scent match, a word to color match, a texture to texture match, a texture to scent match, a texture to color match, a scent to scent match, a scent to color match, a color to color match, or the image on the removable insert could complete a bigger picture on the page once embedded in the cavity, or the actual shape of the removable insert could serve to match the shape of the insert cavity.

All such obvious modification is within the full intended scope of the appended claims, thus the scope of the embodiments should be determined by the appended claims and their legal equivalents, rather than by the examples given.

What is claimed is:

1. A book comprising:
a body including a cover, at least one page, and a binding, wherein a cavity, having an inner surface and a first image disposed on the inner surface, is disposed in the body; and
an insert having an exterior surface and a second image disposed on the exterior surface, wherein the insert is removably disposed in the cavity.

2. The book of claim 1, wherein the first image and the second image are related by a similar theme.

3. The book of claim 1, wherein the first image is not visible when the insert is disposed within the cavity.

4. The book of claim 1, wherein the body is constructed of a rigid material.

5. The book of claim 1, wherein the body is constructed of at least one of cardboard and paper board.
